(19) United States
(12) Patent Application Publication
(10) Pub. No.: US 2014/0380198 A1
(43) Pub. Date: Dec. 25, 2014

(54) METHOD, DEVICE, AND TERMINAL APPARATUS FOR PROCESSING SESSION BASED ON GESTURE

(71) Applicant: XIAOMI INC., Beijing (CN)

(72) Inventors: Bin WANG, Beijing (CN); Daokuan LIU, Beijing (CN); Haibin WENG, Beijing (CN)

(73) Assignee: XIAOMI INC., Beijing (CN)

(21) Appl. No.: 14/294,673

(22) Filed: Jun. 3, 2014

Related U.S. Application Data
(63) Continuation of application No. PCT/CN2014/072327, filed on Feb. 20, 2014.

(30) Foreign Application Priority Data
Jun. 24, 2013 (CN) 201310253279.X

(51) Int. Cl. H04L 12/58; G06F 3/0487

(52) U.S. Cl. CPC H04L 51/04; G06F 3/0487
USPC 715/758

(57) ABSTRACT

A method for processing includes detecting a gesture operation to a session in a current session interface, determining whether the gesture operation is identified, and performing a corresponding processing to the session in the current session interface according to the gesture operation if the gesture operation is identified.

### CROSS REFERENCE TO RELATED APPLICATIONS

This application is a Continuation of International Application No. PCT/CN2014/072327, filed on Feb. 20, 2014, which claims priority to Chinese Patent Application No. 201310253279.X filed on Jun. 24, 2013, the entire contents of both of which are incorporated herein by reference.

### TECHNICAL FIELD

The disclosure relates to the field of communication technology and, more particularly, to a method, device, and terminal apparatus for processing a session based on a gesture.

### BACKGROUND

Instant chat is a common social means on network. Using an instant chat tool, a user may communicate with friends through text, audio, or video. In general, conversations with a friend are within an individual session. This ensures uniqueness, target accuracy, and privacy, of the conversations. When a user joins a session group, words from any friend in the same group can be received by the user at the local terminal. Such a session group may facilitate to improve social activity of users.

However, if the user wants to perform certain operations in a session, he/she must enter the session first, and then perform such operations like reading, deleting, forwarding, etc. When a user is chatting with several friends at the same time, he/she needs to switch among different sessions frequently. Such a procedure is not user friendly, and the efficiency is low.

### SUMMARY

In accordance with embodiments of the disclosure, there is provided a method for processing a session. The method includes detecting a gesture operation to a session in a current session interface, determining whether the gesture operation is identified, and performing a corresponding processing to the session in the current session interface according to the gesture operation if the gesture operation is identified.

Also in accordance with embodiments of the disclosure, there is provided a terminal apparatus. The terminal apparatus includes a processor and a storage storing one or more programs. The one or more programs, when executed by the processor, cause the terminal apparatus to detect a gesture operation to a session in a current session interface, determine whether the gesture operation is identified, and perform a corresponding processing to the session in the current session interface according to the gesture operation if the gesture operation is identified.

Also in accordance with embodiments of the disclosure, there is provided a non-transitory storage medium having stored therein instructions. The instructions, when executed by a processor of a terminal apparatus, cause the terminal apparatus to detect a gesture operation to a session in a current session interface, determine whether the gesture operation is identified, and perform a corresponding processing to the session in the current session interface according to the gesture operation if the gesture operation is identified.

### BRIEF DESCRIPTION OF THE DRAWINGS

FIG. 1 is an illustrative flowchart showing a method for processing a session based on a gesture operation, according to an embodiment.

FIG. 2 is an illustrative flowchart showing a procedure for determining validity of a sliding gesture, according to an embodiment.

FIG. 3a is an illustrative diagram showing a state of an invalid sliding gesture, according to an embodiment.

FIG. 3b is an illustrative diagram showing a state of a valid sliding gesture, according to an embodiment.

FIG. 4 is an illustrative flowchart showing a procedure for determining validity of a clicking gesture, according to an embodiment.

FIG. 5 is an illustrative flowchart showing a procedure for determining validity of a pressing gesture, according to an embodiment.

FIG. 6 is an illustrative flowchart showing a procedure for determining validity of a pressing gesture, according to an embodiment.

FIG. 7 is an illustrative diagram showing a state of a pressing gesture, according to an embodiment.

FIGS. 8a-8c are illustrative diagrams showing a rightward sliding gesture to mark a read state, according to an embodiment.

FIGS. 9a-9c are illustrative diagrams showing placing a session having an unread message at a top of a session interface, according to an embodiment.

FIG. 10 is an illustrative diagram showing sliding a session leftward to display a secondary option, according to an embodiment.

FIG. 11 is an illustrative flowchart showing a method for processing a session based on a gesture operation, according to an embodiment, describing a single-finger sliding rightward to change a mark of the session.

FIG. 12 is an illustrative flowchart showing a method for processing a session based on a gesture operation, according to an embodiment, describing a single-finger downward pressing to display a secondary option.

FIG. 13 is an illustrative diagram showing an upward sliding on a session to display a secondary option, according to an embodiment.

FIG. 14 is an illustrative flowchart showing a method for processing a session based on a gesture operation, according to an embodiment, describing a gesture operation of two-fingers sliding downward to place an unread session at the top of the session interface.

FIG. 15 schematically shows a structure of a device for processing a session based on a gesture option, according to an embodiment.

FIG. 16 is schematically shows a terminal apparatus, according to an embodiment.

### DETAILED DESCRIPTION

Embodiments consistent with the disclosure include a method, device, and terminal apparatus for processing a session based on a gesture.

Hereinafter, embodiments consistent with the disclosure will be described with reference to the drawings. Wherever possible, the same reference numbers will be used throughout the drawings to refer to the same or like parts.

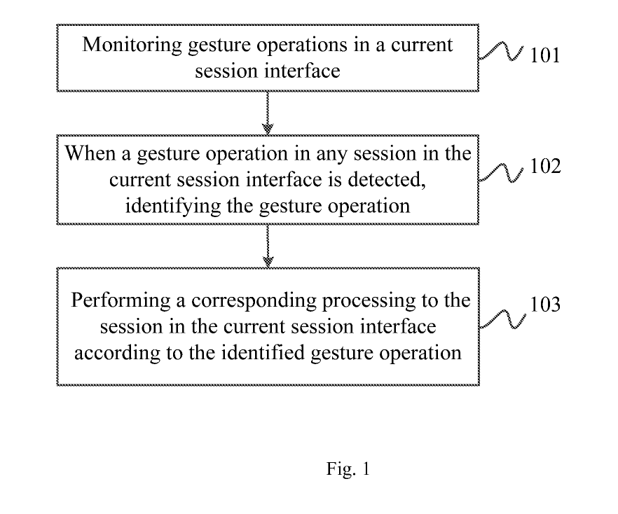

FIG. 1 is an illustrative flowchart showing an exemplary method for processing a session based on a gesture operation, consistent with embodiments of the disclosure.

As shown in FIG. 1, at 101, gesture operations in a current session interface are monitored. At 102, when a gesture operation in any session in the current session interface is detected, the gesture operation is identified. Further, at 103, a corresponding processing is performed on the session in the current session interface, according to the identified gesture operation.

In some embodiments, the gesture operation includes, for example, a single-finger leftward sliding, a single-finger rightward sliding, a multi-finger leftward sliding, a multi-finger rightward sliding, a single-finger upward sliding, a single-finger downward sliding, a multi-finger upward sliding, a multi-finger downward sliding, a single-finger clicking, a multi-finger clicking, a single-finger pressing, or a multi-finger pressing. It is noted that the gesture operations listed above are for illustrative purpose only. Other gesture operations may also be used to initiate processing of a session. For example, a sensor may be used to detect any gesture without the user touching a touch screen.

In some embodiments, the method further includes presetting standard gesture operations and processings corresponding to the standard gesture operations. Thus, identifying the gesture operation (102 in FIG. 1) includes comparing a detected gesture operation with the preset standard gesture operation. If the detected gesture operation matches the preset standard gesture operation, the gesture operation is identified. On the other hand, if the monitored gesture operation does not match the preset standard gesture operation, the gesture operation is not identified. For example, if one preset standard gesture operation is a single-finger sliding and a corresponding processing is to mark a session as read, then when the detected gesture operation on the current session interface is a single-finger sliding, it can be determined that the gesture operation is an identifiable gesture operation.

In some embodiments, after identifying a gesture operation, the method further includes checking a validity of the gesture operation.

In order to improve the accuracy of a gesture operation and avoid misoperation, validity of the identified gesture operation may be checked.

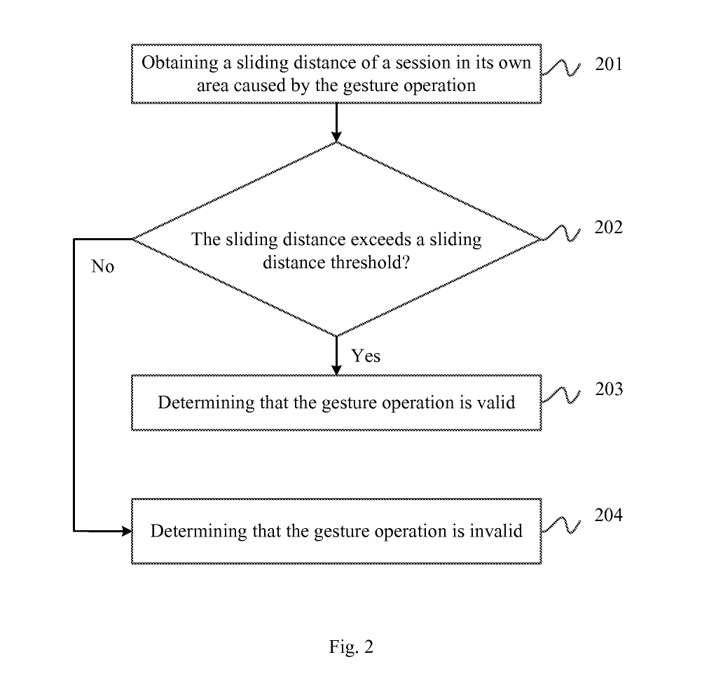

In some embodiments, when a gesture operation is a single-finger leftward sliding, a single-finger rightward sliding, a multi-finger leftward sliding, a multi-finger rightward sliding, a single-finger upward sliding, a single-finger downward sliding, a multi-finger upward sliding, or a multi-finger downward sliding, the validity of the gesture operation is checked. FIG. 2 shows an exemplary processing for checking the validity of the gesture operation.

As shown in FIG. 2, at 201, a sliding distance of a session in its own area caused by the gesture operation is obtained.

At 202, whether the sliding distance exceeds a sliding distance threshold is determined. If the sliding distance exceeds the sliding distance threshold, proceed to 203. Otherwise, proceed to 204.

At 203, the gesture operation is determined to be valid, as the sliding distance exceeds the sliding distance threshold.

At 204, the gesture operation is determined to be invalid, as the sliding distance does not exceed the sliding distance threshold.

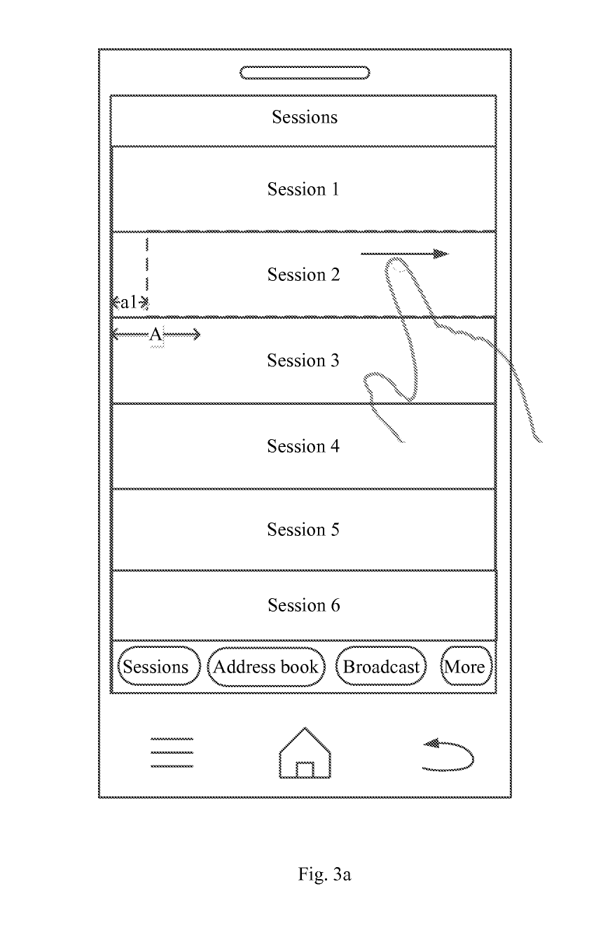

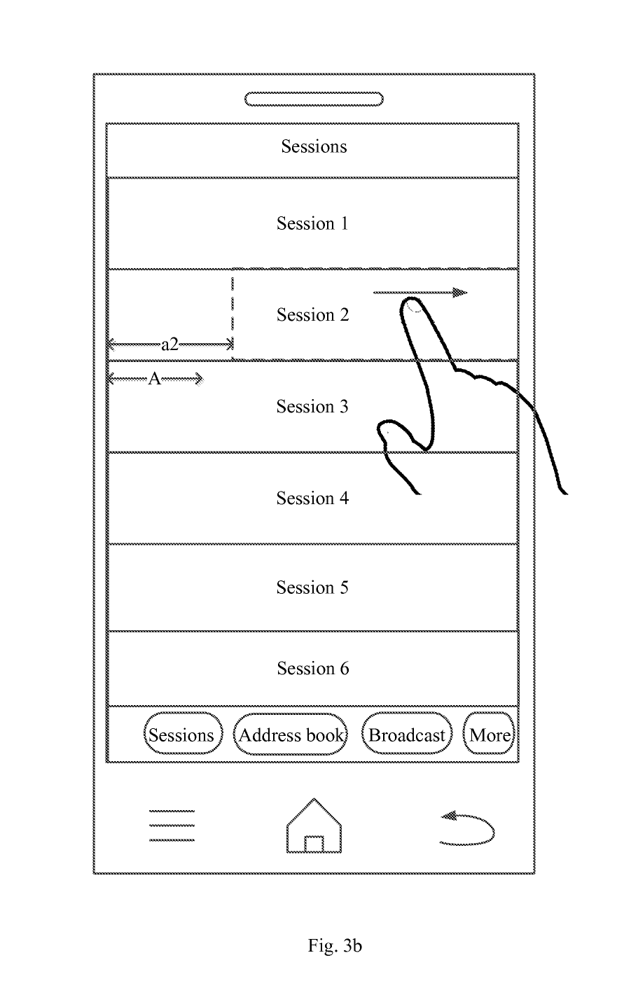

FIGS. 3a and 3b shows an example of a single-finger rightward sliding. As shown in FIG. 3a, a sliding distance of a session in its own area caused by a gesture operation is a1, which is less than a sliding distance threshold A. Therefore, the gesture operation, i.e., the single-finger rightward sliding is determined to be invalid, and is a misoperation. On the other hand, as shown in FIG. 3b, a sliding distance of a session in its own area caused by a gesture operation is a2, which is not less than the sliding distance threshold A. Therefore, the gesture operation, i.e., the single-finger rightward sliding, is determined to be valid, and is a normal operation. Principles for checking the validity of a single-finger leftward sliding, a multi-finger leftward sliding, a multi-finger rightward sliding, a single-finger upward sliding, a single-finger downward sliding, a multi-finger upward sliding, or a multi-finger downward sliding are the same as that for the single-finger rightward sliding, and are thus not repeated here.

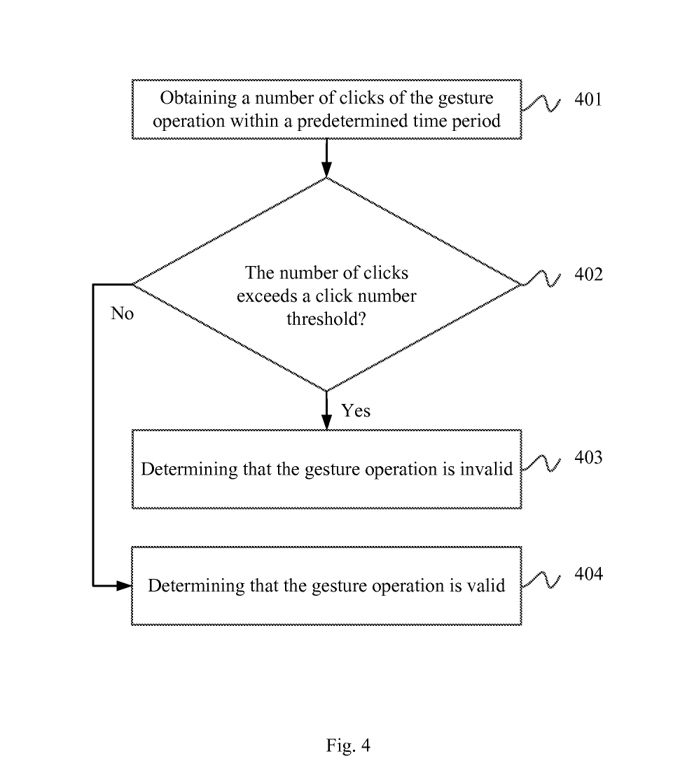

In some embodiments, the gesture operation is a single-finger clicking or a multi-finger clicking, and the validity of the gesture operation is checked. FIG. 4 shows an exemplary processing for checking the validity of the gesture operation.

At 401, a number of clicks of the gesture operation within a predetermined time period is obtained.

At 402, whether the number of clicks of the gesture operation exceeds a click number threshold is checked. If so, proceed to 403. Otherwise, proceed to 404.

At 403, the gesture operation is determined to be invalid, as the number of clicks exceeds the click number threshold.

At 404, the gesture operation is determined to be valid, as the number of clicks does not exceed the click number threshold.

Thus, by detecting the number of clicks, a normal operation and a misoperation can be relatively accurately distinguished from each other.

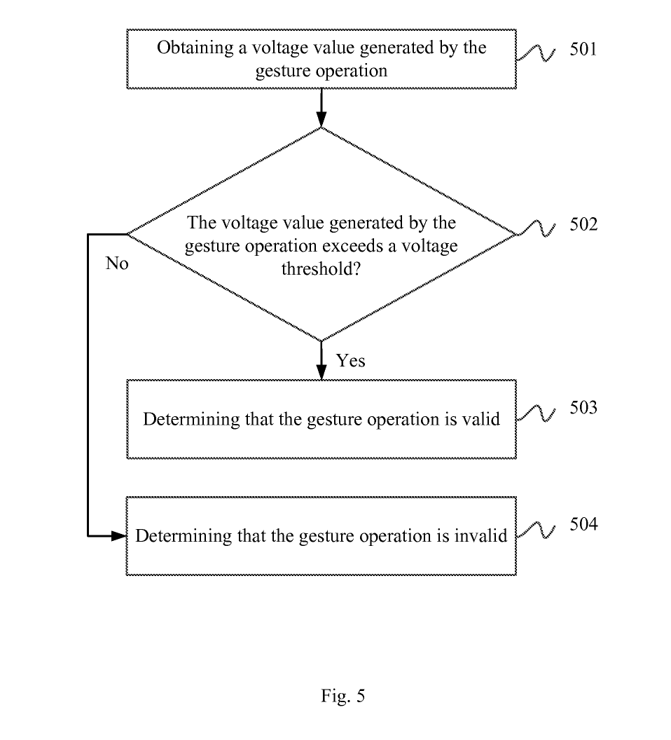

In some embodiments, when a gesture operation is a single-finger pressing or a multi-finger pressing, the validity of the gesture operation is checked. FIG. 5, shows an exemplary processing for determining the validity of the gesture operation.

At 501, a voltage value generated by the gesture operation is obtained.

At 502, whether the voltage value generated by the gesture operation exceeds a voltage threshold is determined. If so, proceed to 503. Otherwise, proceed to 504.

At 503, the gesture operation is determined to be valid, as the voltage value exceeds the voltage threshold.

At 504, the gesture operation is determined to be invalid, as the voltage value does not exceed the voltage threshold.

When a user presses his finger on a touch screen, a value of voltage in a circuit coupled to the touch screen varies, and by determining the value of the voltage, a normal operation and a misoperation can be relatively accurately distinguished from each other.

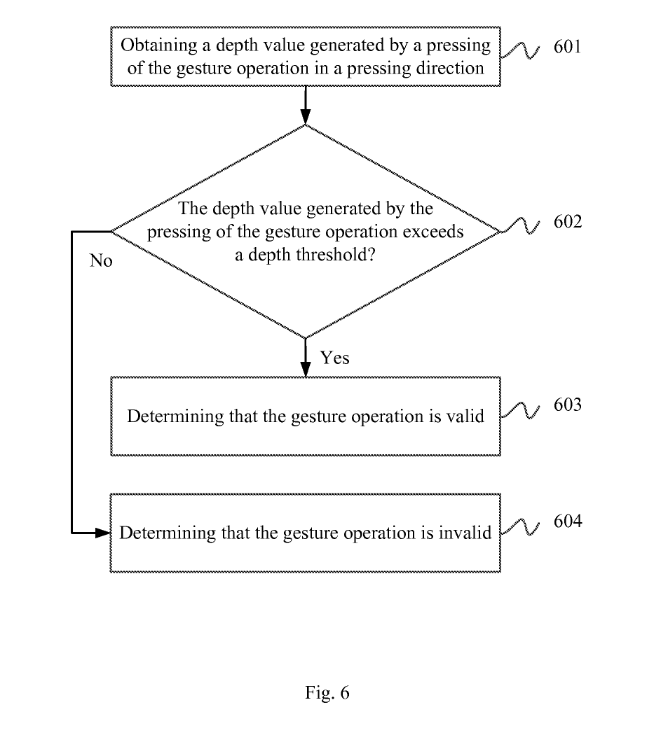

In some embodiments, a screen for displaying a current session interface is a flexible screen. FIG. 6 shows an exemplary processing for determining the validity of a gesture operation, when the screen includes a flexible screen.

At 601, a depth value generated by a pressing of the gesture operation in a pressing direction is obtained.

At 602, whether the depth value of the pressing of the gesture operation exceeds a depth threshold is determined. If so, proceed to 603. Otherwise, proceed to 604.

At 603, the gesture is determined to be valid, as the depth value exceeds the depth threshold.

At 604, the gesture operation is determined to be invalid, as the depth value does not exceed the depth threshold.

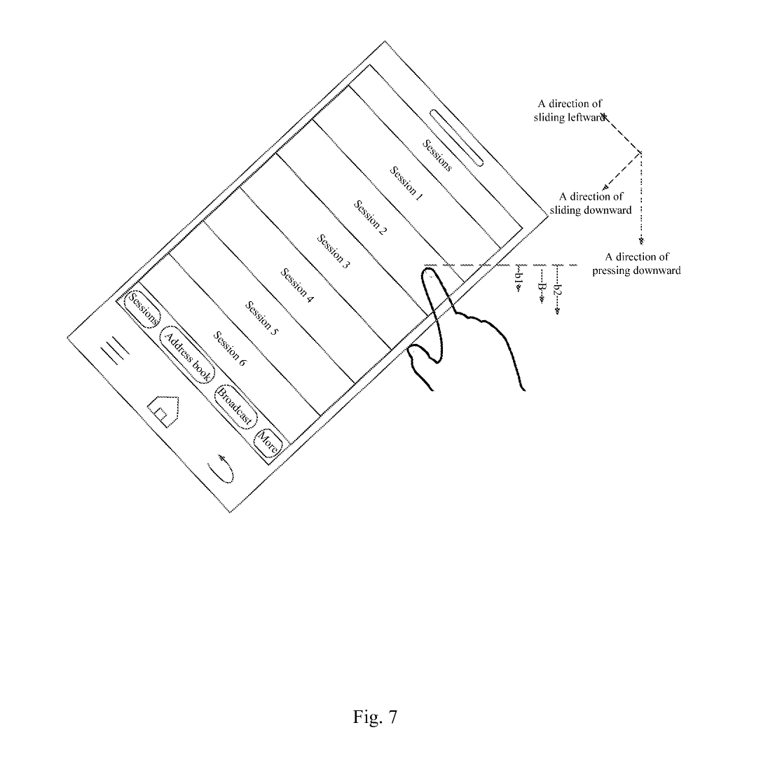

An example of a single-finger downward pressing is described below. As shown in FIG. 7, if a depth value of a pressing of a gesture operation is b1, which is less than a depth threshold B, then the gesture operation of the single-finger downward pressing is determined to be invalid, and is a misoperation. If the depth value of the pressing of the gesture operation is b2, which is not less than the depth threshold B, the gesture operation of the single-finger downward pressing is determined to be valid, and is a normal operation. Principles for determining the validity of a single-finger pressing or a multi-finger pressing in other directions are the same as that for the single-finger downward pressing, and are thus not repeated.

In some embodiments, performing a corresponding processing to a session in a current session interface according an the identified gesture operation includes: when the identified gesture operation is to mark the session as read, updating a state of the session as read; or when the identified gesture operation is to mark the session as deleted, deleting the session from the current session interface; or when the identified gesture operation is to mark the session as forwarded, popping up a forwarding interface of the session. The processings listed above are only examples consistent with embodiments of the disclosure. Other processings may also be included, such as, for example, moving a position of the session.

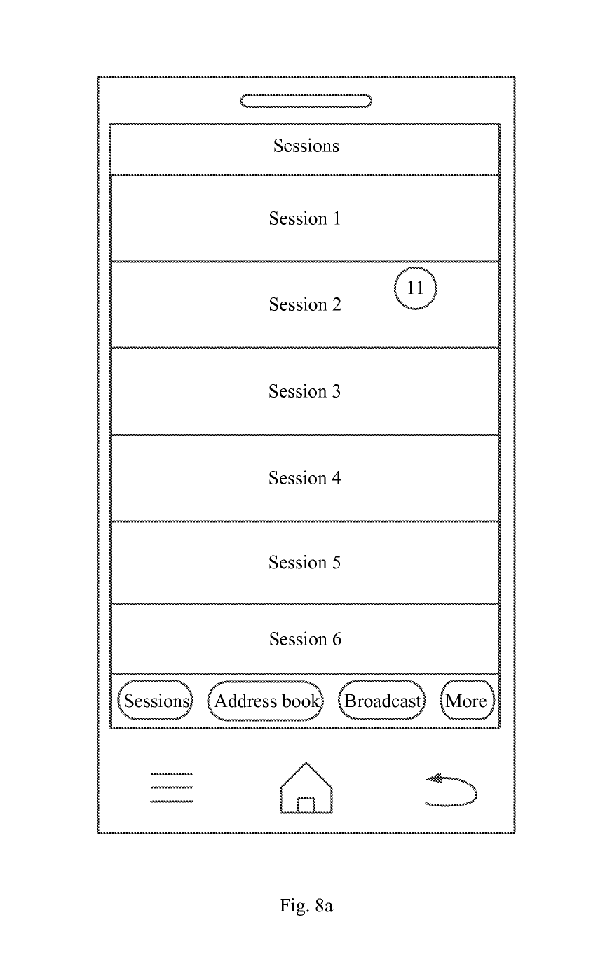

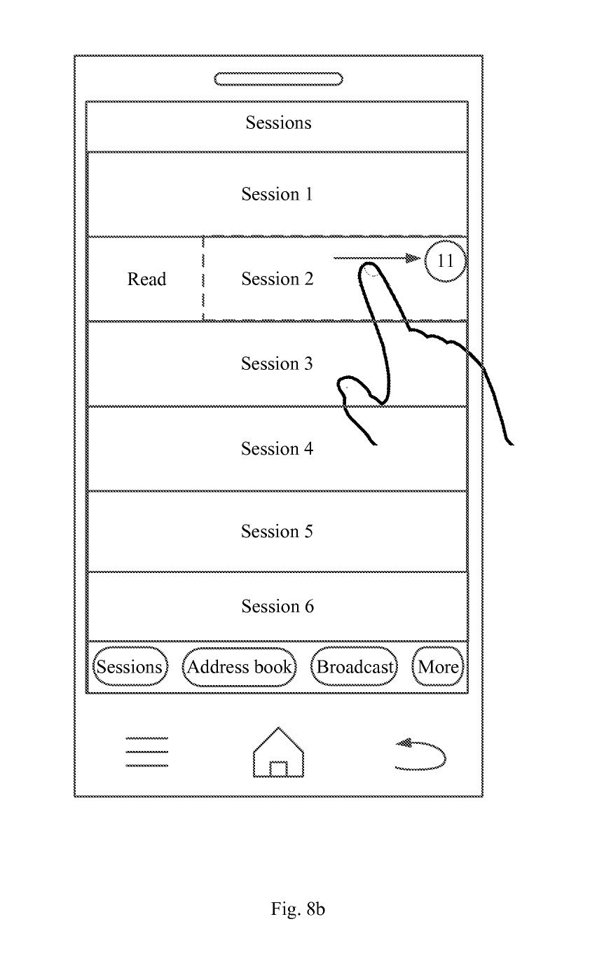

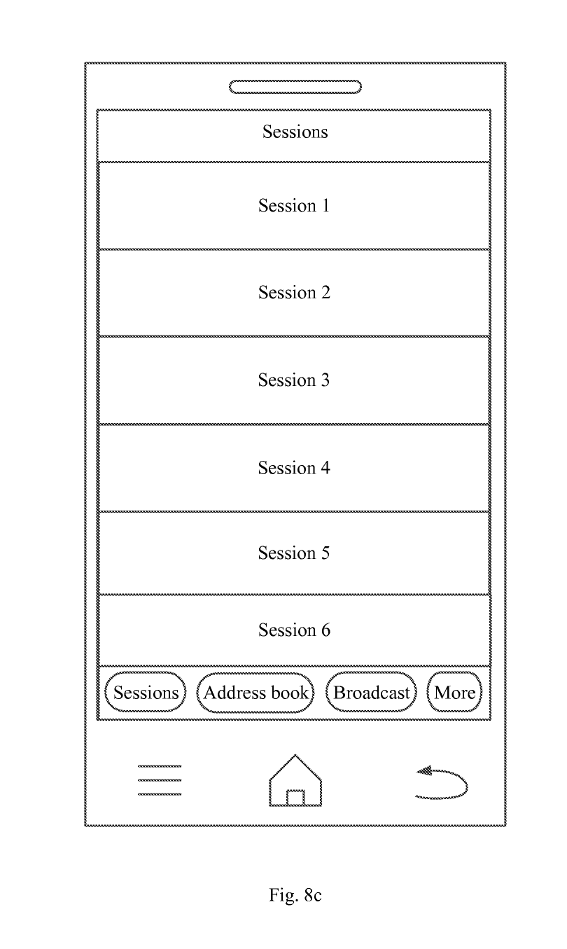

FIGS. 8a-8c illustrate an exemplary processing consistent with embodiments of the disclosure, As shown in FIG. 8a, a session 2 having unread messages is on a current session interface, and the session 2 has eleven unread messages. After a gesture operation with respect to the session 2 is detected and identified, if a processing corresponding to the gesture operation (e.g., a single-finger rightward sliding) is to mark the session 2 as “read”, then, as shown in FIG. 8b, while the session is slid rightward by a single finger, a word “read” can be displayed as a cue in an area that the session has moved through. In some embodiments, other means may be used as a cue, such as other text, picture, and/or animation. As shown in FIG. 8c, after the single-finger rightward sliding ends, the session returns back to its original position, and a springback effect can be displayed after the session returns back to its original position. Meanwhile, prompt information that shows a number of the unread messages also disappear. The prompt information may disappear by moving leftward, or may disappear by fading away.

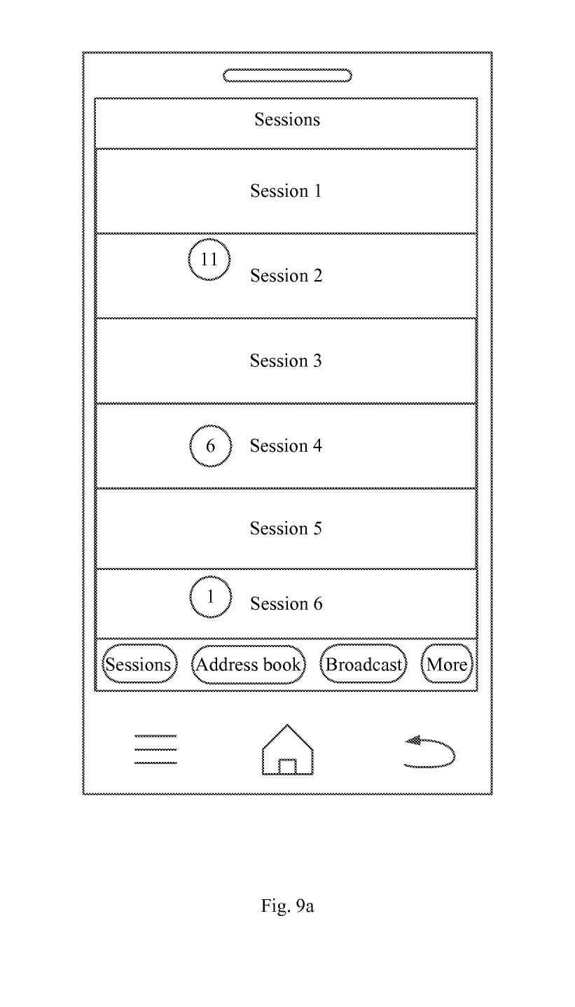

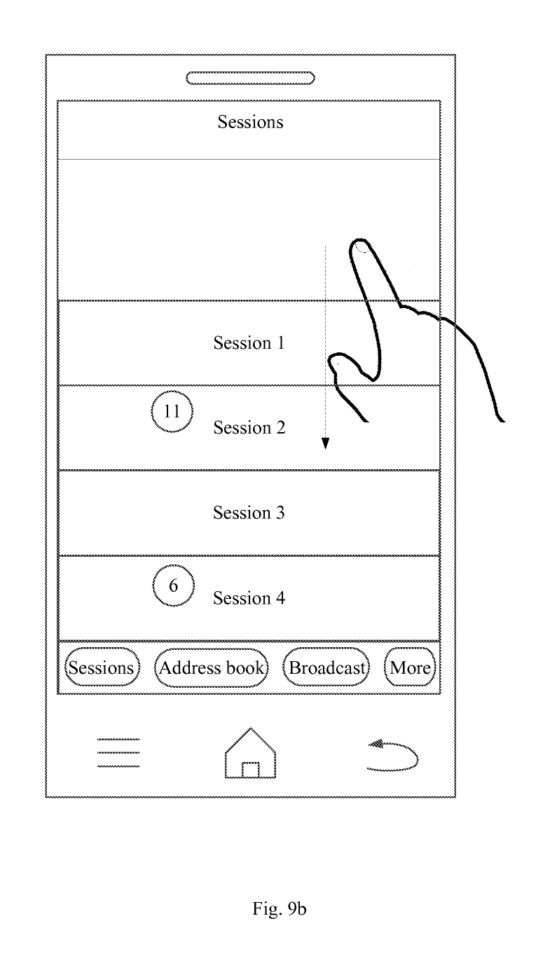

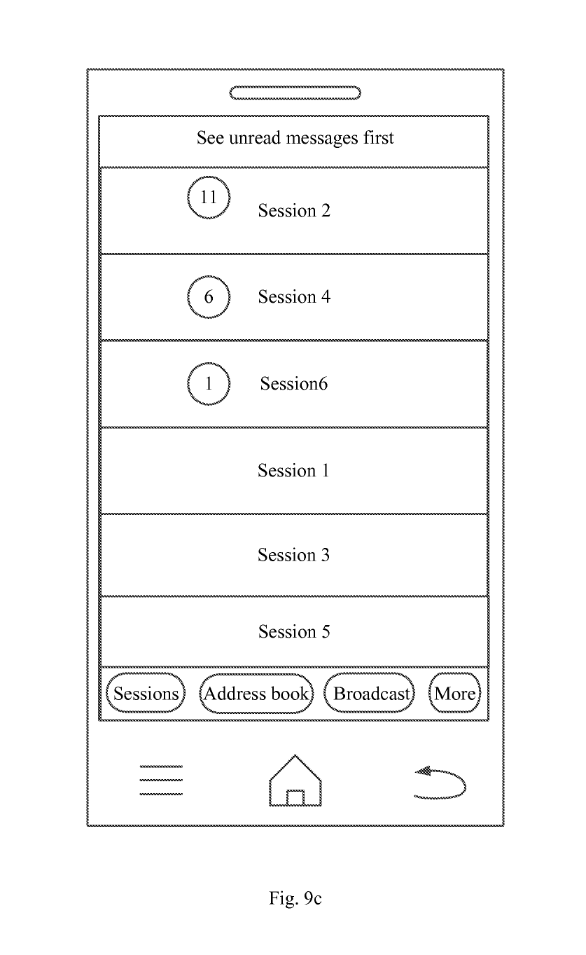

FIGS. 9a-9c illustrate an exemplary processing consistent with embodiments of the disclosure. As shown in FIG. 9a, sessions (session 2, session 4 and session 6) having unread messages are on a current session interface. After a gesture operation on the sessions having unread messages is detected and identified, if a processing corresponding to the gesture operation (such as a single-finger downward sliding) is to place the unread sessions at the top of the display, then, as shown in FIG. 9b, while the sessions are slid downward by a single finger, the current session interface is moved downward as a whole. As shown in FIG. 9c, after the single-finger downward sliding ends, the sessions having unread messages are placed at the top of the display, and a cue may be displayed, indicating that under a current state, the unread sessions are placed at the top. In some embodiments, the single-finger downward sliding may be otherwise defined as placing a certain one or more sessions at the top of the display. In other embodiments, another gesture operation, such as a two-finger downward sliding, is defined as selecting a session and placing it at the top.

In some embodiments, performing a corresponding processing to a session in a current session interface according to an identified gesture includes: when the identified gesture operation is to open a secondary option, moving the session in its own area leftward, rightward, upward, or downward, and displaying the secondary option in the area that the session has passed. The secondary option may include, for example, an operation option with respect to the session, an operation option with respect to the current interface in which the session is located, or an operation option with respect to an application software to which the session belongs.

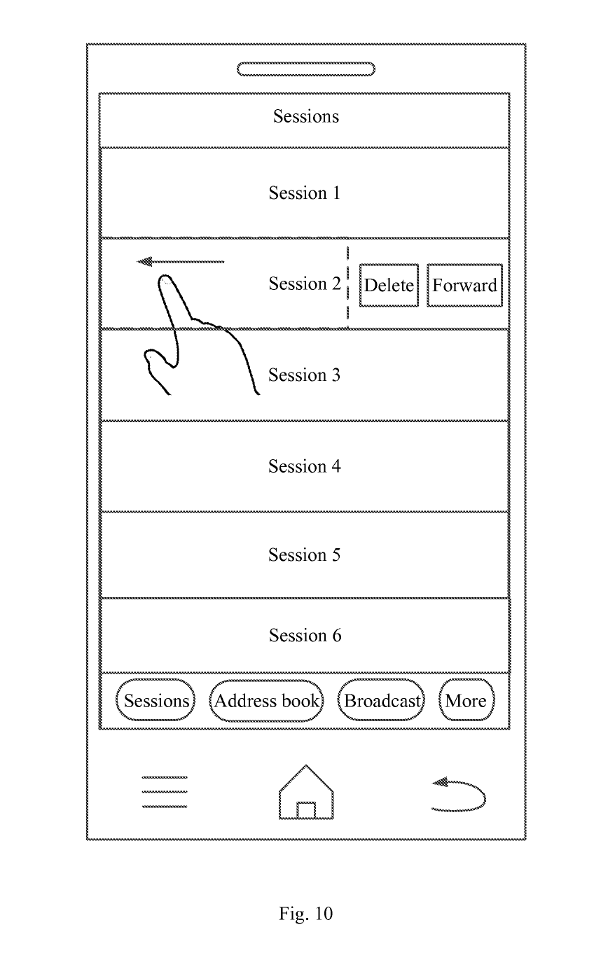

As shown in FIG. 10, when a session is moved leftward by a gesture operation, one or more of secondary options, such as “forward”, “delete”, “move”, “search”, “create a new session”, “press to speak”, and “press to start video”, are displayed in the area that the session has passed. Another gesture operation may also be used to return the session back to its original position. For example, when a single finger clicks the session, the session moves back to its original position and covers the above secondary options.

The embodiments described above may be combined in any form. Details of such combinations are omitted here.

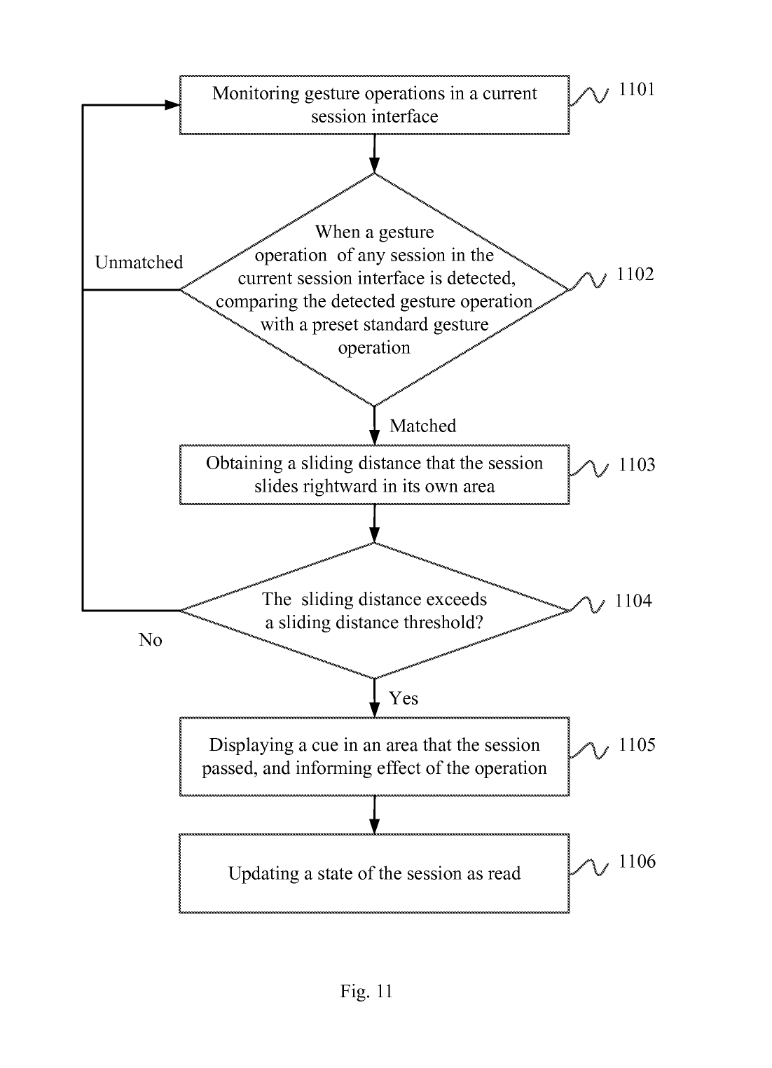

FIG. 11 is a flowchart of a method for processing a session based on gesture operations consistent with embodiments of the disclosure. In FIG. 11, a single-finger rightward sliding to change a mark of the session is illustrated as an example.

As shown in FIG. 11, at 1101, gesture operations in a current session interface are monitored.

At 1102, when a gesture operation of any session in the current session interface is detected, the detected gesture operation is compared with a preset standard gesture operation. If the detected gesture operation and the preset standard gesture operation match each other, the detected gesture operation is identified as a single-finger rightward sliding, and the process proceeds to 1103. If the detected gesture operation and the preset standard gesture operation do not match each other, it is determined that the gesture operation is not identified, and the process returns to 1101.

At 1103, a sliding distance that the session slides rightward in its own area is obtained.

At 1104, it is determined whether the sliding distance exceeds a sliding distance threshold. If the sliding distance exceeds the sliding distance threshold, the gesture operation is determined to be valid, and the process proceeds to 1105. If the sliding distance does not exceed the sliding distance threshold, the gesture operation is determined to be invalid, and the process returns to 1101. Effects of 1104 may be referred to in FIGS. 3a and 3b.

At 1105, a cue in the area that the session has passed is displayed, notifying the user of the effect of the operation. An example of the effect of 1105 is shown in FIG. 8b.

At 1106, a state of the session is updated to be read. An example of the effect of 1106 is shown in FIG. 8c.

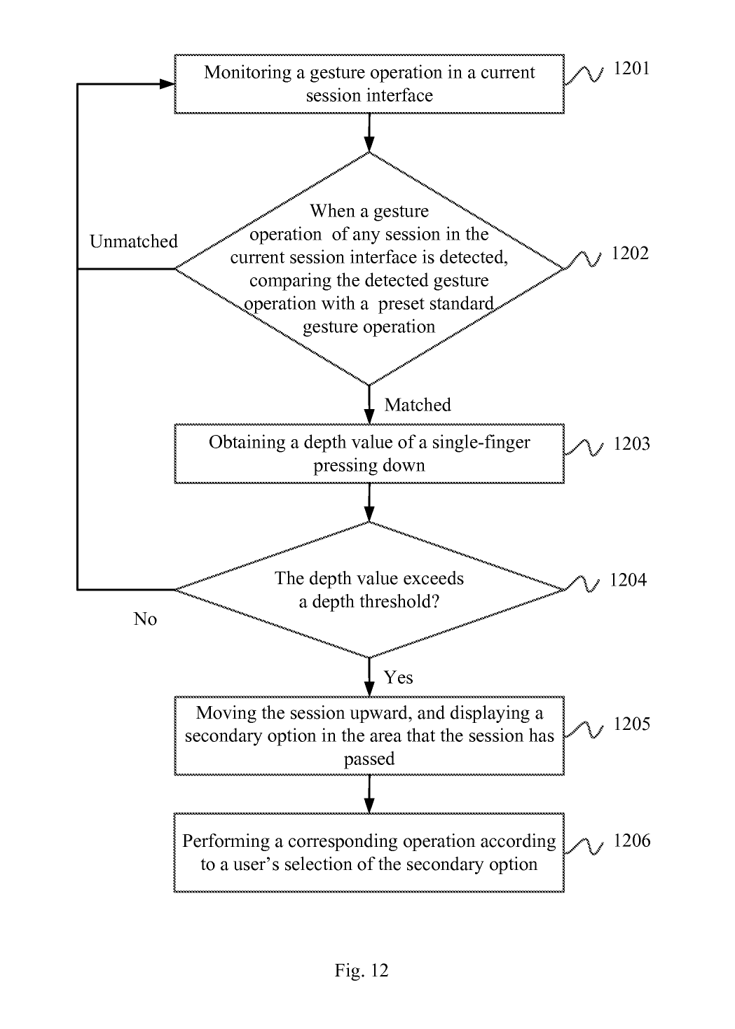

FIG. 12 is a flowchart of a method for processing a session based on gesture operations, consistent with embodiments of the disclosure. In FIG. 12, a single-finger downward pressing to display a secondary option is illustrated as an example.

As shown in FIG. 12, at 1201, gesture operations in a current session interface are monitored.

At 1202, when a gesture operation of any session in the current session interface is detected, the detected gesture operation is compared with a preset standard gesture operation. If the detected gesture operation and the preset standard gesture operation match with each other, the detected gesture operation is identified as a single-finger downward pressing, and the process proceeds to 1203. If the detected gesture operation and the preset standard gesture operation do not match each other, it is determined that the gesture operation is not identified, and the process returns to 1201.

At 1203, a depth value of the single-finger downward pressing is obtained.

At 1204, whether the depth value exceeds a depth threshold is determined. If the depth value exceeds the depth threshold, the gesture operation is determined to be valid, and the process proceeds to 1205. If the depth value does not exceed the depth threshold, the gesture operation is determined to be invalid, and the process proceeds to 1201. An example of the effect of 1204 are shown in FIG. 7.

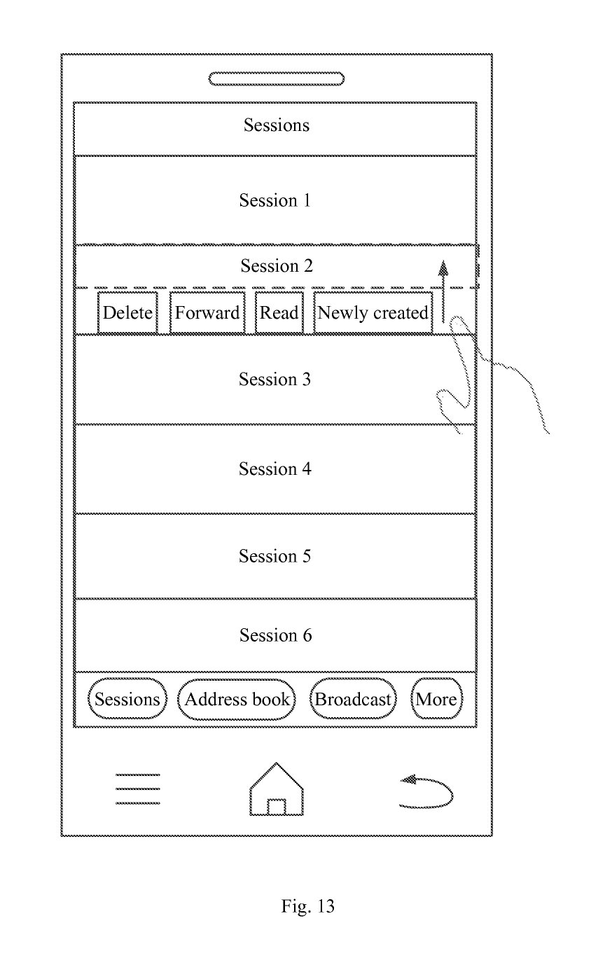

At 1205, the session is moved upward, and secondary options are displayed in the area where the session has passed. As shown in FIG. 13, the session may be continuously moved upward in its own area, even moved to a top of its own position. In some embodiments, the secondary option may also be displayed using effects such as reversion or gradient.

At 1206, a corresponding operation is performed according to a user's selection of the secondary option. For example, after the secondary option “delete” is selected, the session is deleted from the current session interface.

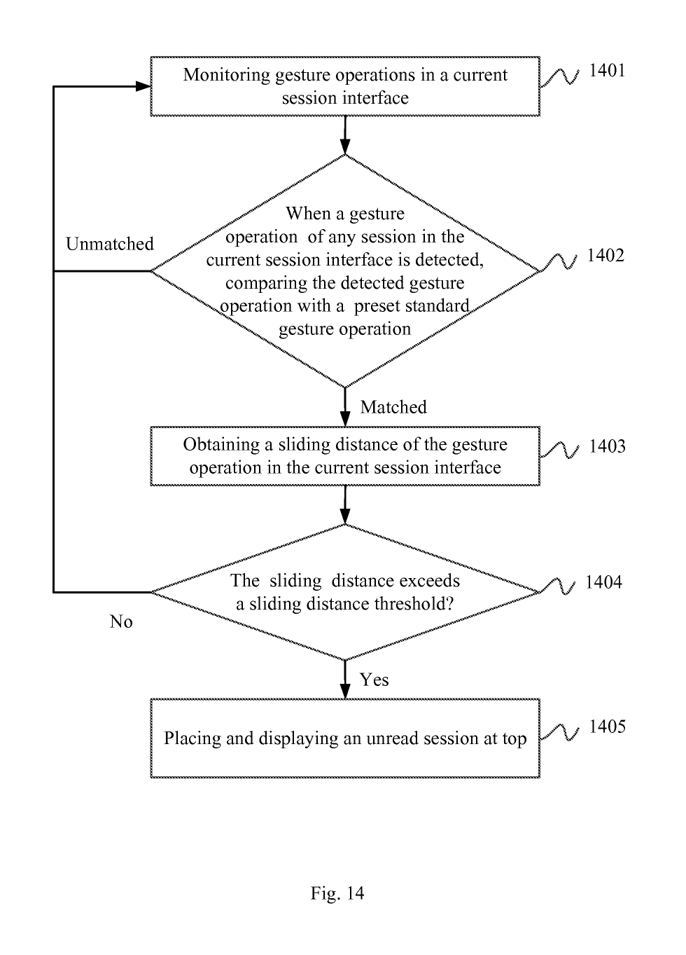

FIG. 14 is a flowchart of a method for processing a session based on gesture operations, consistent with embodiments of the disclosure. In FIG. 14, a gesture operation of two-fingers downward sliding to place an unread session at the top of the session interface is illustrated as an example.

As shown in FIG. 14, at 1401, gesture operations in a current session interface are monitored.

At 1402, when a gesture operation of any session in the current session interface is detected, the detected gesture operation is compared with a preset standard gesture operation. If the detected gesture operation and the preset standard gesture operation match with each other, the detected gesture operation is identified as a two-fingers downward sliding, and the process proceeds to 1403. If the detected gesture operation and the preset standard gesture operation do not match each other, it is determined that the gesture operation is not identified, and the process returns to 1401.

At 1403, a sliding distance that the gesture operation slides in the current session interface is obtained.

At 1404, it is determined whether the sliding distance exceeds a sliding distance threshold. If the sliding distance exceeds the sliding distance threshold, the gesture operation is determined to be valid, and the process proceeds to 1405. If the sliding distance does not exceed the sliding distance threshold, the gesture operation is determined to be invalid, and the process proceeds to 1401.

At 1405, the unread session is placed and displayed at a top of the current session interface. If there are multiple unread sessions, the unread sessions may be ordered according to reception times of the unread sessions or numbers of unread messages in the unread sessions. In some embodiments, only a session at an initial position of the gesture operations is placed and displayed at the top.

As seen above, in the method for processing a session based on gesture operations consistent with embodiments of the disclosure, a gesture operation in a current session interface is detected and identified, and a corresponding processing is performed to the session in the current session interface according to the identified gesture operation. Accordingly, operations can be performed to a session in the current session interface without entering into an operating interface of the session, which shortens the procedure for processing the session, saves processing time, and is more convenient to the users.

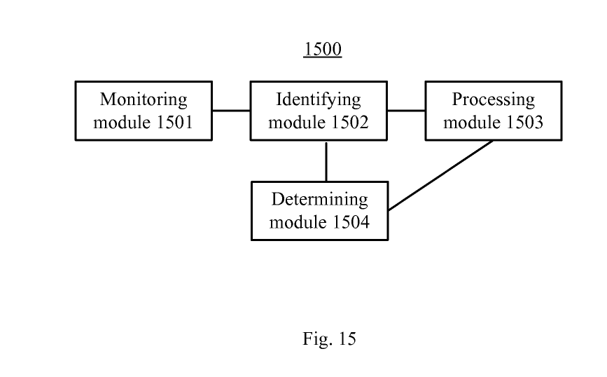

FIG. 15 schematically shows a structure of an exemplary device 1500 for processing a session based on a gesture operation, consistent with embodiments of the disclosure. As shown in FIG. 15, the device 1500 includes a monitoring module 1501 configured to monitor a gesture operation in a current session interface, an identifying module 1502 configured to identify the gesture operation when a gesture operation of any session in the current session interface is detected, and a processing module 1503 configured to perform a corresponding processing to the session in the current session interface according to the identified gesture operation.

In some embodiments, the device 1500 further includes a determining module 1504 configured to determine a validity of a gesture operation.

In some embodiments, if the gesture operation identified by the identifying module 1502 is to mark the session as read, the processing module 1503 updates a state of the session as read. If the gesture operation identified by the identifying module 1502 is to mark the session as deleted, the processing module 1503 deletes the session from the current session interface. If the gesture operation identified by the identifying module 1502 is to mark the session as forwarded, the processing module 1503 pops up a forwarding interface of the session. If the gesture operation identified by the identifying module 1502 is to mark the session as to be placed at the top of the session interface, the processing module 1503 places and displays the session at the top of the current session interface.

In some embodiments, if the gesture operation identified by the identifying module 1502 is to open a secondary option, the processing module 1503 moves the session in its own area leftward, rightward, upward, or downward, and displays the secondary option in the area that the session has passed. The secondary option may include, for example, an operation option with respect to the session, an operation option with respect to the current interface in which the session is located, or an operation option with respect to an application software to which the session belongs.

It is noted that the above modules are described only for illustrative purpose. In actual applications, the operations consistent with embodiments of the disclosure may be implemented by different modules as needed. That is, an internal structure of the apparatus consistent with embodiments of the disclosure may be divided into different modules, to perform all or part of the above-described operations. In addition, the device 1500 for processing a session based on a gesture operation and the method for processing a session based on a gesture operation consistent with embodiments of the disclosure are conceptually similar to each other. Specific implementations of the device 1500 are similar to the embodiments associated with the method as described above, and are therefore not repeated.

Those skilled in the art will now understand that the whole or part of the above-described embodiments may be achieved by hardware, or may be achieved by a program instructing relevant hardware. The program may be stored in a computer readable storage medium, and the storage medium may be, for example, a read only memory, a magnetic disk, or an optical disk.

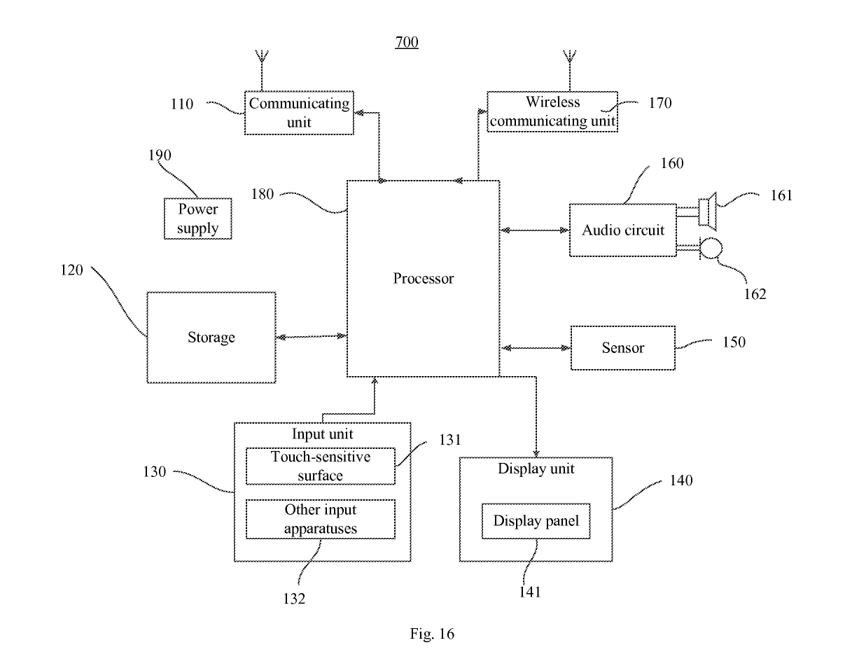

FIG. 16 schematically shows an exemplary terminal apparatus 700 consistent with embodiments of the disclosure. The terminal apparatus 700 may be used to implement the method for processing a session based on a gesture operation consistent with embodiments of the disclosure. The terminal apparatus may be, for example, a telephone, a tablet computer (pad), or a wearable mobile equipment (such as a smart watch).

As shown in FIG. 16, the terminal apparatus 700 includes a communication unit 110, a storage 120 comprising one or more computer readable storage mediums, an input unit 130, a display unit 140, a sensor 150, an audio circuit 160, a WiFi (wireless fidelity) module 170, a processor 180 comprising one or more processing cores, and a power supply 190. Those skilled in the art will understand, the structure of the terminal apparatus 700 shown in FIG. 16 does not limit the terminal apparatus consistent with embodiments of the disclosure. A terminal apparatus consistent with embodiments of the disclosure may include more or less parts than those of FIG. 16, or may combine certain parts, or may have different arrangements of parts.

In FIG. 16, the communication unit 110 may be used to receive or send signals in reception and sending of information or during a call, and the communication unit 110 may be a network communication apparatus such as an RF (Radio Frequency) circuit, a router, or a modulator-demodulator. Particularly, if the communication unit 110 is an RF circuit, after downlink information is received from a base station, the communication unit 110 sends the downlink information to one or more processors 180 for processing. In addition, the communication unit 110 sends uplink data to the base station. Generally, the RF circuit as the communication unit 110 includes, but is not limited to, an antenna, at least one amplifier, a tuner, one or more oscillators, a subscriber identity module (SIM) card, a transceiver, a coupler, an LNA (Low Noise Amplifier), a duplexer, and etc. Furthermore, the communication unit 110 may also communicate with a network and other apparatuses by wireless communication. The wireless communication may use any communication standard or protocol including, but not limited to, GSM (Global System of Mobile communication), GPRS (General Packet Radio Service), CDMA (Code Division Multiple Access), WCDMA (Wideband Code Division Multiple Access), LTE (Long Term Evolution), E-mail, SMS (Short Messaging Service), and etc.

The storage 120 may be used to store software programs and modules, and the processor 180 executes various kinds of function applications and data processings by operating the software programs and modules stored in the storage 120. The storage 120 may mainly include a program storing area and a data storing area, wherein the program storing area may store an operating system, at least one application program required for functions such as a sound playing function, an image playing function, etc. The data storing area may store data such as audio data, a telephone book, etc., created in accordance with the use of the terminal apparatus 700. Furthermore, the storage 120 may include a high speed random access memory, a nonvolatile memory such as at least one magnetic disk storage device or a flash memory device, or other storage devices such as volatile solid-state memory devices. Correspondingly, the storage 120 may also include a storage controller, to provide the processor 180 and the input unit 130 with an access to the storage 120.

The input unit 130 may be used to receive figures or character information that are input, and generate signal input of a keyboard, a mouse, an operating stick, an optical device, or a trackball related to user settings and function control. For example, the input unit 130 may include a touch-sensitive surface 131 and other input apparatuses 132. The touch-sensitive surface 131 which is also referred to as a touch display screen or a touch panel, may collect touch operations from a user thereon or nearby (for example, operations on the touch-sensitive surface 131 or nearby the touch-sensitive surface 131 by a user using any appropriate object or accessory such as a finger, or a touch pen, etc.), and may drive a corresponding connecting device according to a preset program. Optionally, the touch-sensitive surface 131 may include two portions of a touch detection device and a touch controller. Wherein the touch detection device detects touch orientations of a user, and detects signals brought up by touch operations, then transmits the signals to the touch controller. The touch controller receives touch information from the touch detection device, and converts the touch information into coordinates of touch points to be sent to the processor 180, and the touch controller receives commands sent from the processor 180 and executes the commands. Furthermore, the touch-sensitive surface 131 may be realized by using various types of manners such as resistance-type, capacitance-type, infrared ray, or surface acoustic wave. In addition to the touch-sensitive surface 131, the input unit 130 may also include other input apparatuses 132. For example, the other input apparatuses 132 may include, but are not limited to, one or more of a physical keyboard, a function key (such as a volume control key, or a switching key, etc.), a trackball, a mouse, or an operating stick.

The display unit 140 may be used to display information input by a user or information supplied to the user and various kinds of graphical user interfaces of the terminal apparatus 700, and these graphical user interfaces may consist of graph, text, icon, video, or any combination thereof. The display unit 140 may include a display panel 141, and optionally, the display panel 141 may be configured by using LCD (Liquid Crystal Display), OLED (Organic Light-Emitting Diode) or the like. Further, the touch-sensitive surface 131 may cover the display panel 141, and after the touch-sensitive surface 131 detects touch operations thereon or nearby, the touch-sensitive surface 131 transmits the touch operations to the processor 180 to determine types of touch events. Subsequently, the processor 180 provides a corresponding visual output on the display panel 141 according to the types of the touch events. Although in FIG. 16, the touch-sensitive surface 131 and the display panel 141 realize input and output functions as two separate parts, in certain embodiments, the touch-sensitive surface 131 and the display panel 141 may be integrated to realize the input and output functions.

The terminal apparatus 700 may also include at least one sensor 150 such as a light sensor, a motion sensor, or other sensors. For example, the light sensor may include an ambient light sensor or a proximity sensor, wherein the ambient light sensor may adjust luminance of the display panel 141 according to luminance of ambient light, while the proximity sensor may turn off the display panel 141 and/or its backlight when the terminal apparatus 700 moves to an ear. As one of motion sensors, a gravity acceleration sensor may detect values of accelerations in respective directions (usually, three-axis), and may detect a value and a direction of gravity when being static, and may be used in applications for identifying a phone pose (such as switching between horizontal and vertical screens, related games, magnetometer pose calibration), related functions of vibration identification (such as a pedometer, a knock), etc. The terminal apparatus 700 may also be configured with other sensors such a gyroscope, a barometer, a hygrometer, a thermometer, an infrared sensor, etc.

The audio circuit 160, a speaker 161 and a microphone 162 may provide an audio interface between a user and the terminal apparatus 700. The audio circuit 160 may convert received audio data into electrical signals and transmit the electrical signals to the speaker 161, then the speaker 161 converts the electrical signals into sound signals to be output. On the other hand, the microphone 162 converts collected sound signals into electrical signals, the audio circuit 160 receives the electrical signals and converts the electrical signals into audio data, the audio data is output to the processor 180 to be processed. Then the audio data is sent to another terminal apparatus through the communication unit 110, or the audio data is output to the storage 120 to be further processed. The audio circuit 160 may include an earplug jack, to provide communication between a peripheral headset and the terminal apparatus 700.

In order to realize wireless communication, the terminal apparatus 700 includes a wireless communication unit 170. The wireless communication unit 170 may be a WiFi module. WiFi is a short-distance wireless transmission technology. Through the wireless communication unit 170, the terminal apparatus 700 may assist a user to receive or send emails, browse webpages, or access streaming media, providing the user with wireless broadband Internet access. Although FIG. 16 shows the wireless communication unit 170, it shall be understood that the terminal apparatus 700 does not have to include the wireless communication unit 170, and the wireless communication unit 170 can be completely omitted as needed within a scope that does not change the nature of the disclosure.

The processor 180 is a control center of the terminal apparatus 700, coupling to respective parts of the entire terminal apparatus 700 by using various kinds of interfaces and circuits. The processor 180 executes various kinds of functions of the terminal apparatus 700 and processes data by operating or executing software programs and/or modules stored in the storage 120 and calling data stored in the storage 120, and thereby monitors the entire terminal apparatus 700. Optionally, the processor 180 may include one or more processing cores. For example, the processor 180 may integrate an application processor and a modulation-demodulation processor, wherein the application processor mainly processes an operating system, a user interface, and an application program, and the modulation-demodulation processor mainly processes wireless communication. It may be understood that the modulation-demodulation processor may not be integrated into the processor 180.

The terminal apparatus 700 also includes the power supply 190 (such as a battery) that supplies power to the respective parts. For example, the power supply 190 may be logically coupled with the processor 180 by a power supply management system, thereby realizing functions such as management of charging, discharging, and power consumption by the power supply management system. The power supply 190 may also include a component such as one or more DC or AC power supplies, recharging systems, power supply failure detection circuits, power supply converters or inverters, or power supply state indicators.

Although not shown, the terminal apparatus 700 may also include a camera, or a Bluetooth module, which are not described here. Specifically, in some embodiments, a display unit of the terminal apparatus is a touch screen display, and the terminal apparatus further includes a storage, and one or more programs, wherein the one or more programs are stored in the storage. The one or more programs include instructions that, when executed by one or more processors of the terminal apparatus, cause the terminal apparatus to monitor gesture operations in a current session interface, identify a detected gesture operation of any session in the current session interface, and perform a corresponding processing to the session in the current session interface according to the identified gesture operation.

In some embodiments, the storage further includes instructions for presetting a standard gesture operation and a processing corresponding to the standard gesture operation.

In some embodiments, identifying the detected gesture operation includes comparing the monitored gesture operation with the preset standard gesture operation. If the detected gesture operation and the preset standard gesture operation match each other, the instructions cause the terminal apparatus to determine that the gesture operation is identified. If the detected gesture operation and the preset standard gesture operation do not match each other, the instructions cause the terminal apparatus to determine that the gesture operation is not identified.

In some embodiments, the storage further includes instructions for determining validity of the gesture operation after the gesture operation is identified.

In some embodiments, the storage further includes instructions for determining the validity of the gesture operation when the gesture operation is a single-finger leftward sliding, a single-finger rightward sliding, a multi-finger leftward sliding, a multi-finger rightward sliding, a single-finger upward sliding, a single-finger downward sliding, a multi-finger upward sliding, or a multi-finger downward sliding. Specifically, the instructions cause the terminal apparatus to obtain a sliding distance of the session in its own area slid by the gesture operation, determine whether the sliding distance exceeds a sliding distance threshold, determine that the gesture operation is valid if the sliding distance exceeds the sliding distance threshold, and determine that the gesture operation is invalid if the sliding distance does not exceed the sliding distance threshold.

In some embodiments, the storage further includes instructions for determining the validity of the gesture operation when the detected gesture operation is a single-finger clicking or a multi-finger clicking. Specifically, the instructions cause the terminal apparatus to obtain a number of clicks of the gesture operation within a predetermined time period, determine whether the number of clicks of the gesture operation exceeds a click number threshold, determine that the gesture operation is invalid if the number of clicks exceeds the click number threshold, and determine that the gesture operation is valid if the number of clicks does not exceed the click number threshold.

In some embodiments, the storage further includes instructions for determining the validity of the gesture operation when the gesture operation is a single-finger pressing or a multi-finger pressing. Specifically, the instructions cause the terminal apparatus to obtain a voltage value generated by the gesture operation, determine whether the voltage value generated by the gesture operation exceeds a voltage threshold, determine that the gesture operation is valid if the voltage value exceeds the voltage threshold, and determine that the gesture operation is invalid if the voltage value does not exceed the voltage threshold.

Alternatively, if a display screen for displaying the current session interface is a flexible screen, the instructions cause the terminal apparatus to obtain a depth value generated by a pressing of the gesture operation in a pressing direction, determine whether the depth value generated by the pressing of the gesture operation exceeds a depth threshold, determine that the gesture operation is valid if the depth value exceeds the depth threshold, and determine that the gesture operation is invalid if the depth value does not exceed the depth threshold.

In some embodiments, the instructions that cause the terminal apparatus to perform the corresponding processing to the session in the current session interface according to the identified gesture operation specifically cause the terminal apparatus to update a state of the session as read if the identified gesture operation is to mark the session as read, delete the session from the current session interface if the identified gesture operation is to mark the session as deleted, pop up a forwarding interface of the session if the identified gesture operation is to mark the session as forwarded, or place and display the session at a top of the current session interface if the identified gesture operation is to mark the session as being placed at the top.

In some embodiments, the instructions that cause the terminal apparatus to perform the corresponding processing to the session in the current session interface according to the identified gesture operation specifically cause the terminal apparatus to move the session in its own area leftward, rightward, upward, or downward, and displaying a secondary option in the area that the session has passed, when the identified gesture operation is to open the secondary option. The secondary option includes an operation option with respect to the session, an operation option with respect to the current interface in which the session is located, or an operation option with respect to an application software to which the session belongs.

In some embodiments, there is also provided a non-transitory storage medium having stored therein instructions that, when executed by one or more processors of a terminal apparatus, causes the terminal apparatus to monitor gesture operations in a current session interface, identify a detected gesture operation to any session in the current session interface, and perform a corresponding processing to the session in the current session interface according to the identified gesture operation.

As seen from above, according to the methods, devices, and terminal apparatus for processing a session based on gesture operations consistent with embodiments of the disclosure, gesture operations in a current session interface are monitored, a detected gesture operation identified, and a corresponding processing is performed to the session in the current session interface according to the identified gesture operation. Accordingly, operations can be performed to a session in the current session interface without entering into an operating interface of the session, which shortens the procedure for processing the session, saves processing time, and is more convenient to the users.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing a session, comprising:
detecting a gesture operation to a session in a current session interface;
determining whether the gesture operation is identified; and
performing a corresponding processing to the session in the current session interface according to the gesture operation if the gesture operation is identified.

2. The method according to claim 1, wherein the gesture operation includes at least one of a single-finger leftward sliding, a single-finger rightward sliding, a multi-finger leftward sliding, a multi-finger rightward sliding, a single-finger upward sliding, a single-finger downward sliding, a multi-finger upward sliding, a multi-finger downward sliding, a single-finger clicking, a multi-finger clicking, a single-finger pressing, or a multi-finger pressing.

3. The method according to claim 1, further comprising:
presetting a standard gesture operation,
wherein determining whether the gesture operation is identified includes:
comparing the gesture operation with the standard gesture operation;
determining that the gesture operation is identified if the detected gesture operation and the preset standard gesture operation match each other; and
determining that the gesture operation is not identified if the detected gesture operation and the preset standard gesture operation do not match each other.

4. The method according to claim 3, further comprising:
presetting a processing corresponding to the standard gesture operation,
wherein performing the corresponding processing to the session includes performing the preset processing to the session.

5. The method according to claim 1, further comprising:
determining a validity of the gesture operation after the gesture operation is identified.

6. The method according to claim 5, wherein:
the gesture operation includes at least one of a single-finger leftward sliding, a single-finger rightward sliding, a multi-finger leftward sliding, a multi-finger rightward sliding, a single-finger upward sliding, a single-finger downward sliding, a multi-finger upward sliding, or a multi-finger downward sliding, and
determining the validity of the gesture operation includes:
obtaining a sliding distance of the session in an own area of the session slid by the gesture operation;
determining whether the sliding distance exceeds a sliding distance threshold;
determining that the gesture operation is valid if the sliding distance exceeds the sliding distance threshold; and
determining that the gesture operation is invalid if the sliding distance does not exceed the sliding distance threshold.

7. The method according to claim 5, wherein:
the gesture operation includes at least one of a single-finger clicking or a multi-finger clicking, and
determining the validity of the gesture operation includes:
obtaining a number of clicks of the gesture operation within a predetermined time period;
determining whether the number of clicks exceeds a click number threshold;
determining that the gesture operation is invalid if the number of clicks exceeds the click number threshold; and
determining that the gesture operation is valid if the number of clicks does not exceed the click number threshold.

8. The method according to claim 5, wherein:
the gesture operation includes at least one of a single-finger pressing or a multi-finger pressing, and
determining the validity of the gesture operation includes:
obtaining a voltage value generated by the gesture operation;
determining whether the voltage value exceeds a voltage threshold;
determining that the gesture operation is valid if the voltage value exceeds the voltage threshold; and
determining that the gesture operation is invalid if the voltage value does not exceed the voltage threshold.

9. The method according to claim 5, wherein:
a display screen for displaying the current session interface includes a flexible screen,
the gesture operation includes at least one of a single-finger pressing or a multi-finger pressing, and
determining the validity of the gesture operation includes:
obtaining a depth value generated by a pressing of the gesture operation in a pressing direction on the flexible screen;
determining whether the depth value exceeds a depth threshold;
determining that the gesture operation is valid if the depth value exceeds the depth threshold; and
determining that the gesture operation is invalid if the depth value does not exceed the depth threshold.

10. The method according to claim 1, wherein performing the corresponding processing to the session in the current session interface according to the gesture operation includes:
updating a state of the session as read if the gesture operation is to mark the session as read;
deleting the session from the current session interface if the gesture operation is to mark the session as deleted;
popping up a forwarding interface of the session if the gesture operation is to mark the session as forwarded; or
placing and displaying the session at a top of the current session if the gesture operation is to mark the session as placed at the top.

11. The method according to claim 1, wherein:
performing the corresponding processing to the session in the current session interface according to the identified gesture operation includes:
moving, if the gesture operation is to open a secondary option, the session in an own area of the session leftward, rightward, upward, or downward; and
displaying the secondary option in an area that the session has passed,
wherein the secondary option includes at least one of an operation option with respect to the session, an operation option with respect to the current session interface, or an operation option with respect to an application software to which the session belongs.

12. A terminal apparatus comprising:
a processor; and
a storage storing one or more programs, the one or more programs, when executed by the processor, causing the terminal apparatus to:
detect a gesture operation to a session in a current session interface;
determine whether the gesture operation is identified; and
perform a corresponding processing to the session in the current session interface according to the gesture operation if the gesture operation is identified.

13. A non-transitory storage medium having stored therein instructions that, when executed by a processor of a terminal apparatus, cause the terminal apparatus to:
detect a gesture operation to a session in a current session interface;
determine whether the gesture operation is identified; and
perform a corresponding processing to the session in the current session interface according to the gesture operation if the gesture operation is identified.
